(19) United States
(12) Patent Application Publication
(10) Pub. No.: US 2017/0274829 A1
(43) Pub. Date: Sep. 28, 2017

(54) INTERIOR AND EXTERIOR CARGO MANAGEMENT SYSTEM INCORPORATING A GRATE

(71) Applicant: FORD GLOBAL TECHNOLOGIES, LLC, Dearborn, MI (US)

(72) Inventors: Annette Lynn Huebner, White Lake, MI (US); Ryan Welch, Ottawa Lake, MI (US); Joshua Greiner, Detroit, MI (US); Matthew B. Rutman, Canton, MI (US); Christopher Nichols, Sears, MI (US); Leon Drake Carpenter, Chelsea, MI (US)

(21) Appl. No.: 15/080,742

(22) Filed: Mar. 25, 2016

(51) Int. Cl. B60R 9/06

(52) U.S. Cl. CPC B60R 9/06; B60R 9/10

(57) ABSTRACT

A cargo management system is provided for a motor vehicle. That cargo management system includes a grate that is displaceable between a first use position mounted inside the motor vehicle and a second use position mounted outside the motor vehicle. The grate is a versatile performer suited for a wide range of storage applications.

### TECHNICAL FIELD

This document relates generally to the motor vehicle equipment field and, more particularly, to a cargo management system incorporating a grate that is displaceable between a first use position inside the motor vehicle and a second use position outside the motor vehicle. Such a cargo management system provides enhanced versatility for meeting the storage and hauling needs of motor vehicle operators.

### BACKGROUND

Many motor vehicle operators live active and adventurous lifestyles. This seems to be particularly true of those driving sport utility vehicles (SUVs). As a consequence, those operators are looking for “tools” to help them quickly and easily adapt the motor vehicle to better accommodate them in their activities.

This document relates to a new and improved cargo management system that incorporates a grate that is displaceable between a first use position inside the motor vehicle and a second use position outside of the motor vehicle. The ability to effectively utilize the cargo management system within the passenger cabin and outside the vehicle provides enhanced versatility allowing the cargo management system to be effectively utilized to meet a wide range of application and storage needs in a manner not previously available in the art.

Those applications include, but are not limited to, interior storage space for wet/dirty clothes/gear, infinite cargo area tie-down locations both inside and outside of the vehicle, exterior cargo carrier capability and exterior bike hauling function.

### SUMMARY

In accordance with the purposes and benefits described herein, a cargo management system is provided for a motor vehicle. That cargo management system comprises a grate that is displaceable between a first use position mounted in a passenger cabin/inside the motor vehicle and a second use position mounted outside the motor vehicle. That grate may include a hitch bar. That hitch bar is displaceable between a stored position where it is telescopingly received within a support tube for the grate and a deployed position where the hitch bar extends from the support tube.

The cargo management system may further include a receiver in the motor vehicle for receiving and holding the grate in the first use position. That receiver may comprise opposed slide channels. The grate is held in the opposed slide channels when in the first use position. Further, the hitch bar is held in the storage position when the grate is in the first hitch position.

The cargo management system may also further include a storage pan that nests in a cavity in the floor of the motor vehicle under the grate when the grate is in the first use position. In addition, the cargo management system may further include a latch mechanism for securing the grate in the first use position over the storage pan.

Still further, the cargo management system may further include a perimeter flange that extends around the grate. In such an embodiment, the perimeter flange projects from the grate around a first face of the grate.

When the cargo management system is used outside or exterior to the motor vehicle, the hitch bar is displaced into the deployed position and is received in a hitch receiver of the motor vehicle to secure the grate in the second use position. The grate may be oriented with the first face and the perimeter flange upward. Further, the perimeter flange may include an integrated bicycle mount. That integrated bicycle mount may include a circular bead formed in the perimeter flange at a first end of the grate and a notch formed in a second, opposite end of the grate. In addition, the cargo management system may include a skewer and a strap. The skewer may be utilized to secure the front fork of the bicycle to the circular bead while the strap may be utilized to secure the rear wheel of the bicycle in the notch.

In the following description, there are shown and described several preferred embodiments of the cargo management system. As it should be realized, the cargo management system is capable of other, different embodiments and its several details are capable of modification in various, obvious aspects all without departing from the cargo management system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the cargo management system and together with the description serve to explain certain principles thereof. In the drawing figures:

FIG. 1 is a partially exploded perspective view of a first embodiment of the cargo management system including a grate, opposed side channels for securing the grate in a first use position inside the motor vehicle and a storage pan that nests in a cavity in the floor of the cargo vehicle under the grate.

FIG. 2 is a detailed perspective view illustrating the positioning of the opposed side channels and storage pan in the rear of the SUV.

FIG. 3 is a cross-sectional view showing the ends of the grate received in the opposed channels and the floor pan below the grate sitting in a cavity in the SUV's floor. Wet clothes are resting on the grate and dripping into the underlying pan.

FIG. 4 is a view similar to FIG. 3 showing the grate flipped over so that the face of the grate is down and the perimeter frames or flange of the grate is projecting upward above the grate face.

FIG. 5 is a detailed view illustrating the center support tube of the grate which holds a telescoping hitch bar. The telescoping hitch bar is illustrated in the stowed position in phantom line and in the deployed position in full line.

FIG. 6 is a perspective view showing the grate mounted on the exterior of the SUV with the hitch bar received in a hitch receiver of the SUV.

FIG. 7 is a view similar to FIG. 6 but showing the storage pan nested in the sidewall of the grate and held in place by two bungee cords.

FIG. 8 is a perspective view illustrating how a bicycle may be secured to the grate at the exterior rear of the SUV.

FIGS. 8a and 8b are detailed views illustrating, respectively, the skewer that attaches the front fork of the bicycle to the bead formed in one end of the perimeter flange of the grate and the strap utilized to secure the rear wheel of the bicycle to the notch formed in the opposite end of the perimeter flange of the grate.

FIG. 9 is a perspective view of an alternative embodiment wherein the hitch bar is pivotally attached through the grate.

FIGS. 9a and 9b illustrate the alternative embodiment of the grate attached to a hitch receiver in two different positions.

FIG. 10 illustrates an embodiment wherein the grate is secured by bolts to a roof rack of the motor vehicle.

Reference will now be made in detail to the present preferred embodiments of the cargo management system, examples of which are illustrated in the accompanying drawing figures.

### DETAILED DESCRIPTION

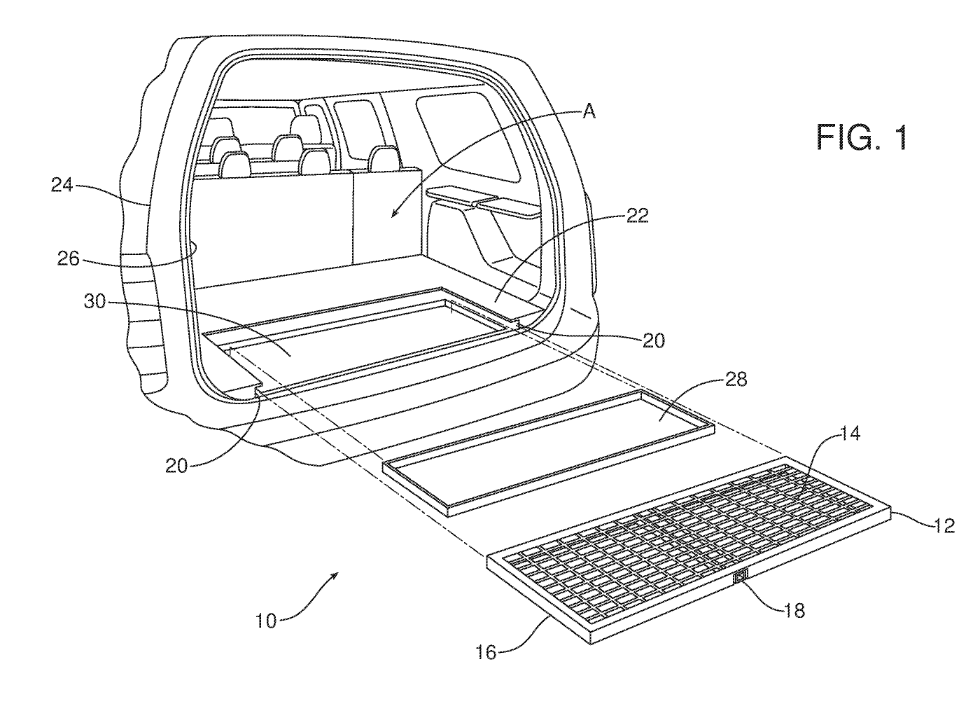

Reference is now made to FIG. 1, illustrating a first embodiment of the cargo management system 10. As illustrated, that cargo management system 10 includes a grate 12 including a perforated face 14, a perimeter flange 16 extending around the face 14 and a central support tube 18.

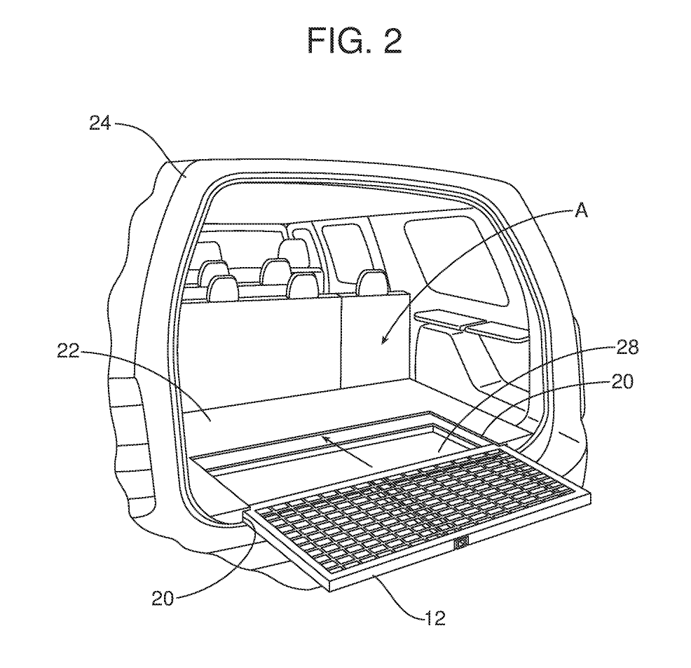

As further illustrated in FIGS. 1 and 2, the cargo management system 10 also includes a receiver 20. In the illustrated embodiment, the receiver 20 comprises opposed slide channels that may be provided as an integral part of the floor 22 of the cargo area A of the sport utility vehicle 24. As should be appreciated from viewing FIG. 1, the ends of the opposed channels 20 are open toward the tailgate opening 26 (tailgate not shown).

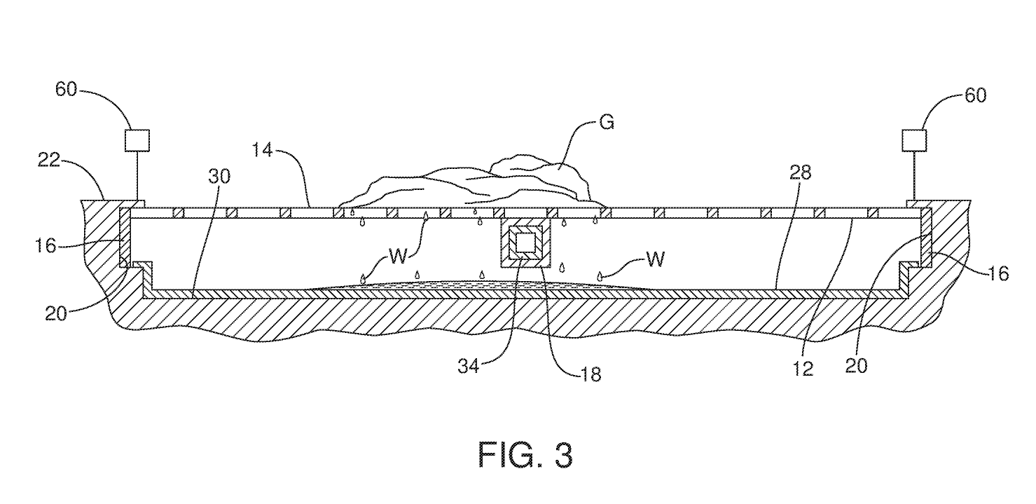

As should be appreciated, the grate 12 and the perimeter flange 16 are sized and shaped to allow one to slide the grate 12 into the opposed channels 20 through the tailgate opening 26 into a first use position within the interior of the SUV 24. As illustrated in FIGS. 2 and 3, the grate 12 may be positioned in the opposed channels 20 with the perforated face 14 up.

As further illustrated in FIGS. 1-3, the cargo management system 10 may also include a storage pan 28. As illustrated in FIG. 3, that storage pan 28 may be received in and nest in a cavity 30 provided in the floor 22 of the SUV 24. Thus, as illustrated in FIG. 3, wet gear G may be positioned on the face 14 of the grate 12 overlying the storage pan 28 which is in position to receive and hold any droplets of water W dripping from the gear. Of course, the pan 28 may be easily removed from the cavity 30 for cleaning as desired.

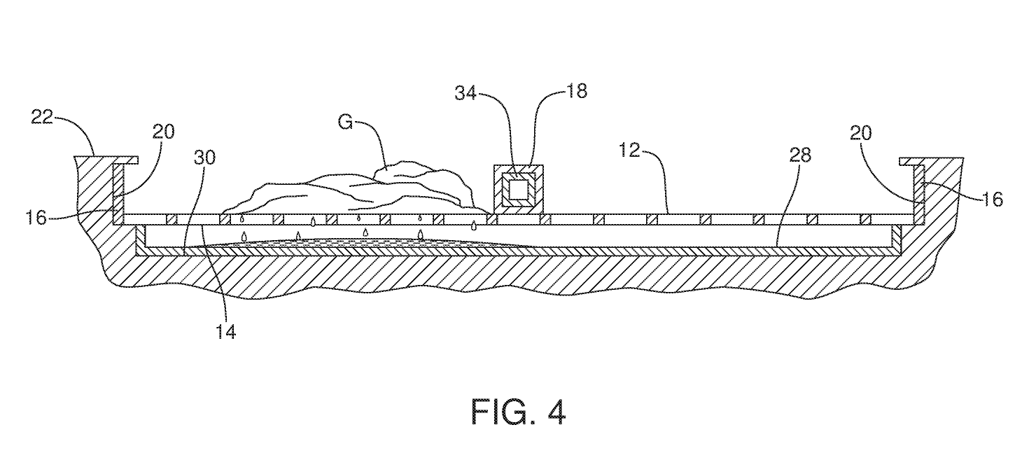

In an alternative configuration illustrated in FIG. 4, the grate 12 may be positioned in the opposed channels 20 with the perforated face 14 down and the perimeter flange 16 extending upwardly. In this configuration, the perimeter flange 16 forms a sidewall for holding anything placed on the grate 12 in position.

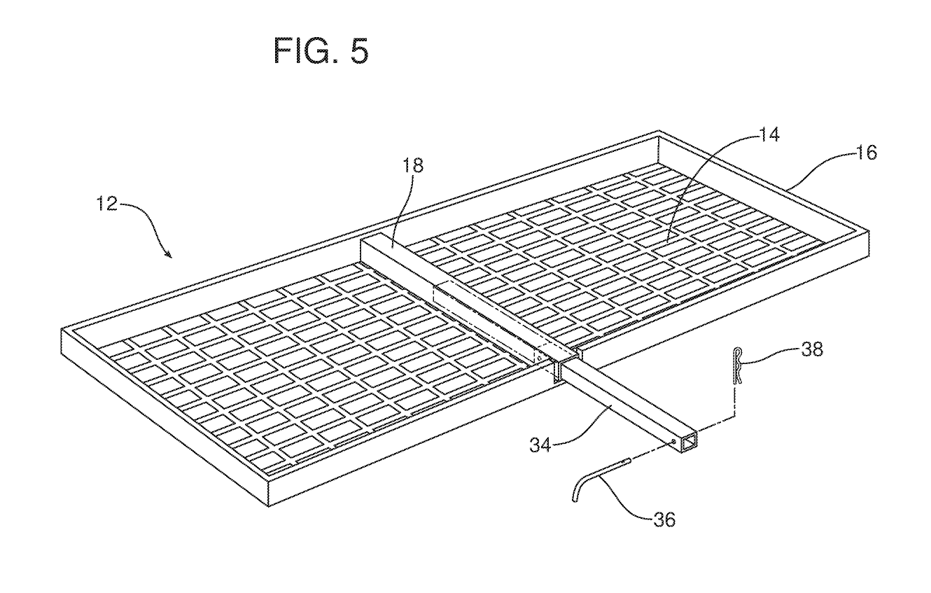

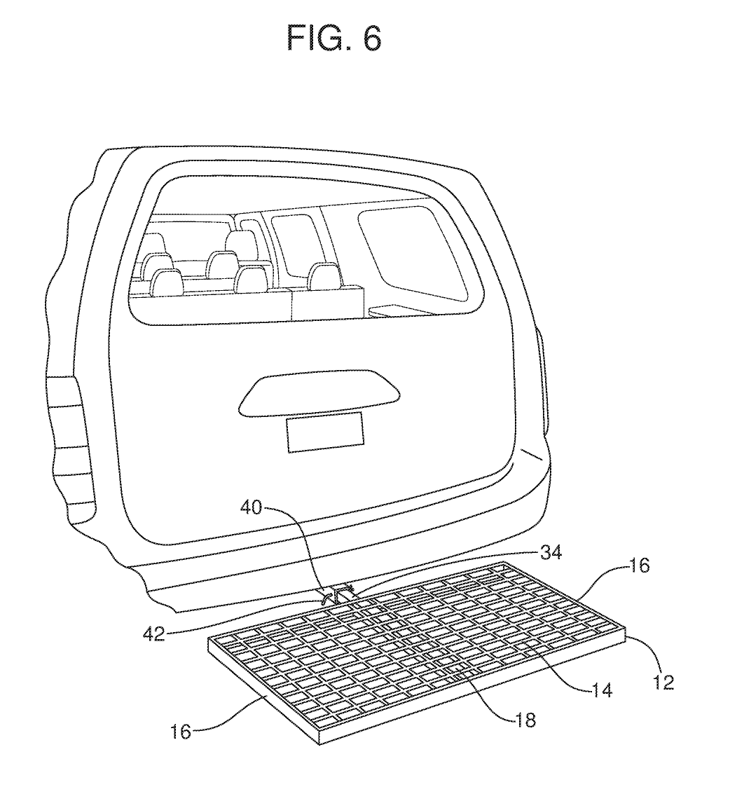

As best illustrated in FIG. 4, the grate 12 may also include a hitch bar 34 that is slidingly or telescopingly received within the support tube 18 so as to be displaceable between a stowed or retracted position illustrated in phantom line and a deployed or extended position illustrated in full line. The hitch bar 34 may be secured in either the stowed or deployed position by means of the pin 36 and cooperating clip 38. As illustrated in FIGS. 1-4, the hitch bar 34 is maintained in the stowed position when the grate 12 is in the first use position in the interior of the SUV 24. In contrast, the hitch bar 34 is in the deployed position and inserted into a hitch receiver 40 of the SUV 24 when the grate 12 is in the second or exterior use position (See FIGS. 5 and 6). A hitch pin 42 secures the hitch bar 34 in the hitch receiver 40.

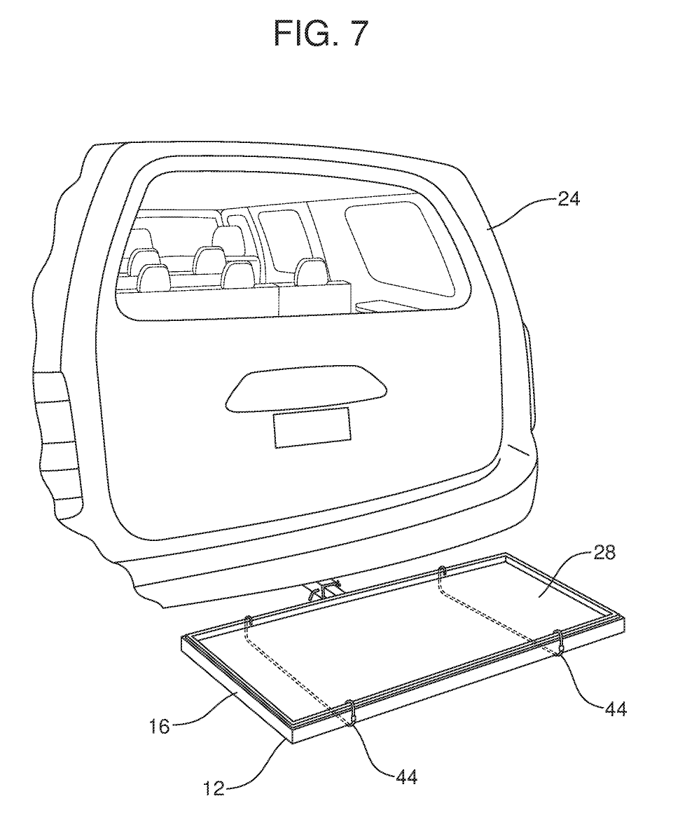

As should be appreciated from reviewing FIG. 6, the grate 12 may be secured in the second use position in the hitch receiver 40 with the perforated face 14 oriented upward. Alternatively, the grate 12 may be secured in the second use position with the perforated face 14 oriented downward and the perimeter flange 16 extending upward. As illustrated in FIG. 7a, if desired, the storage pan 28 may be removed from the cavity 30 in the floor 32 of the SUV 24 and positioned on the perforated face 14 nested within the perimeter flange 16 of the grate 12 if one wishes to close the openings in the perforated face 14 for storing or carrying any particular material. In such an embodiment, the pan 28 includes a hump to accommodate the support tube 18. A strap or other fastener such as a bungee cord 44 may be utilized to secure the storage pan 28 in this nested position.

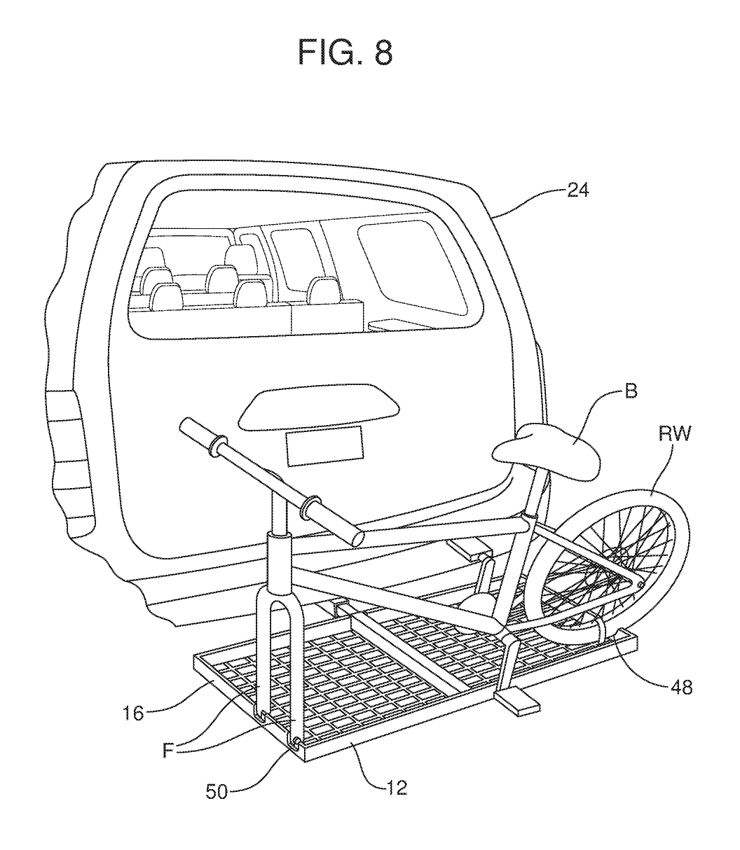

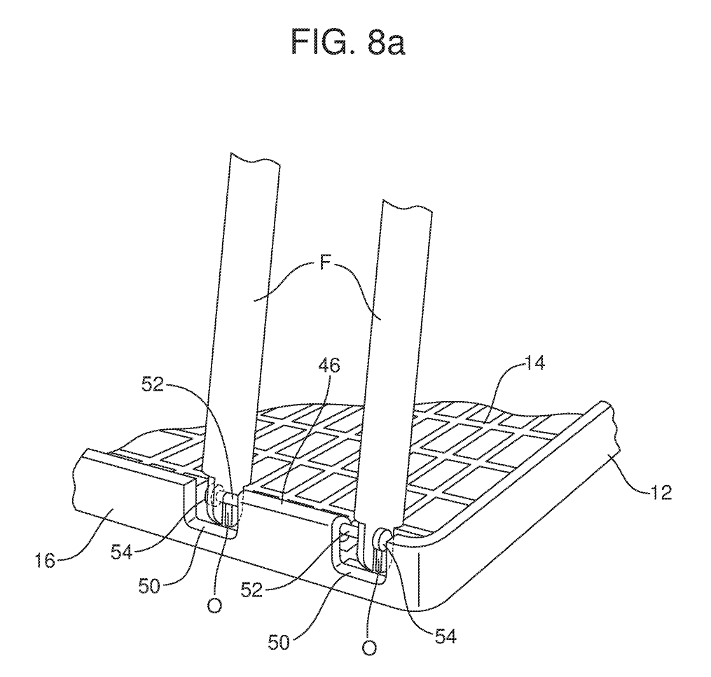

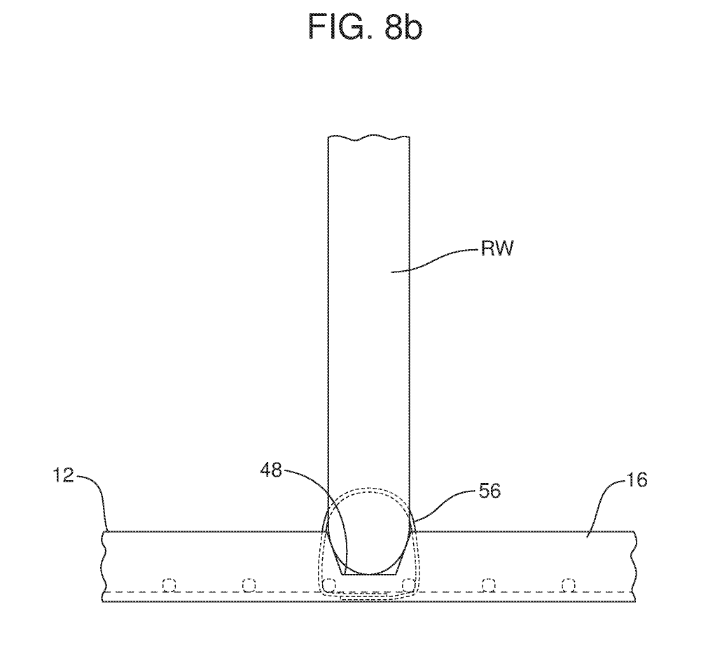

Reference is now made to FIG. 8 illustrating how the grate 12, when in the second or exterior position, may be utilized to carry a bicycle B. As shown, the perimeter flange 16 includes an integrated bicycle mount comprising a circular or tubular bead 46 formed at a first end or side and a notch 48 formed at a second end or side of the grate 12.

As best illustrated in FIG. 8a, the front fork F of the bicycle B is positioned in the slots 50 at each end of the tubular bead 46 and a skewer 52 is inserted through the axle mount openings 0 and the tubular bead 46. The end caps 54 function to lock the front fork F to the tubular bead 46 of the perimeter flange 16.

As best illustrated in FIG. 8b, the rear wheel RW of the bicycle B is positioned in the notch 48 in the perimeter flange 16 and a strap 56 or other appropriate attachment device such as a bungee cord is used as a tie-down to secure the rear wheel in the notch.

The foregoing has been presented for purposes of illustration and description. It is not intended to be exhaustive or to limit the embodiments to the precise form disclosed. Obvious modifications and variations are possible in light of the above teachings. For example, a latch mechanism 60, schematically illustrated in FIG. 3, may be provided to lock the grate 12 in the first use position overlying the storage pan 28 if desired. When locked in position, the perforated facel4 of the grate 12 effectively provides a nearly infinite number of anchor points or locations to tie down an object in the back of the SUV 24.

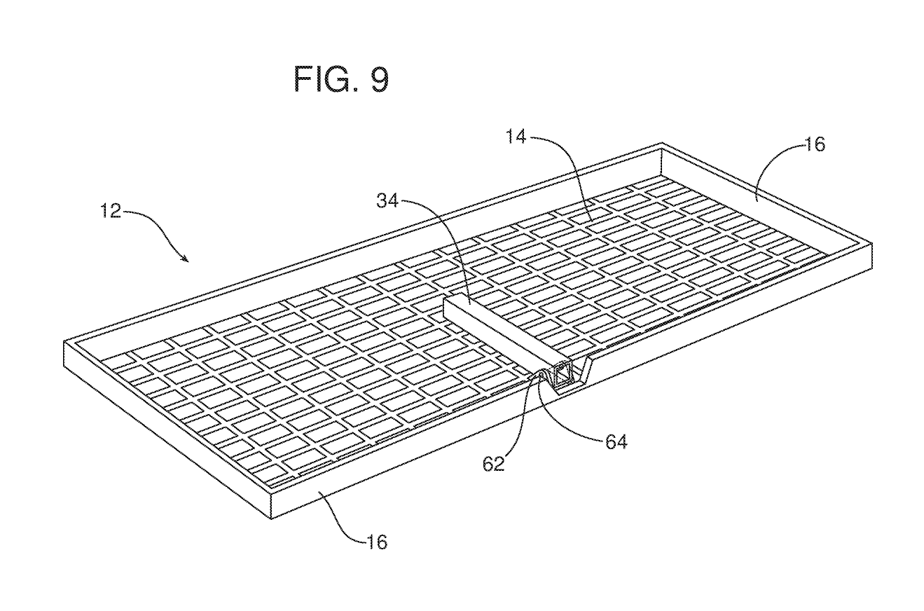

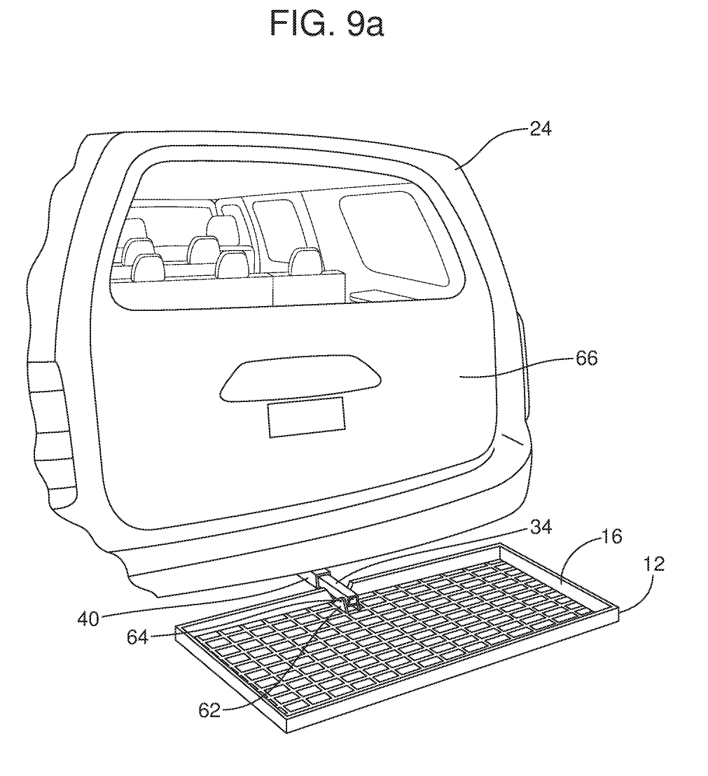

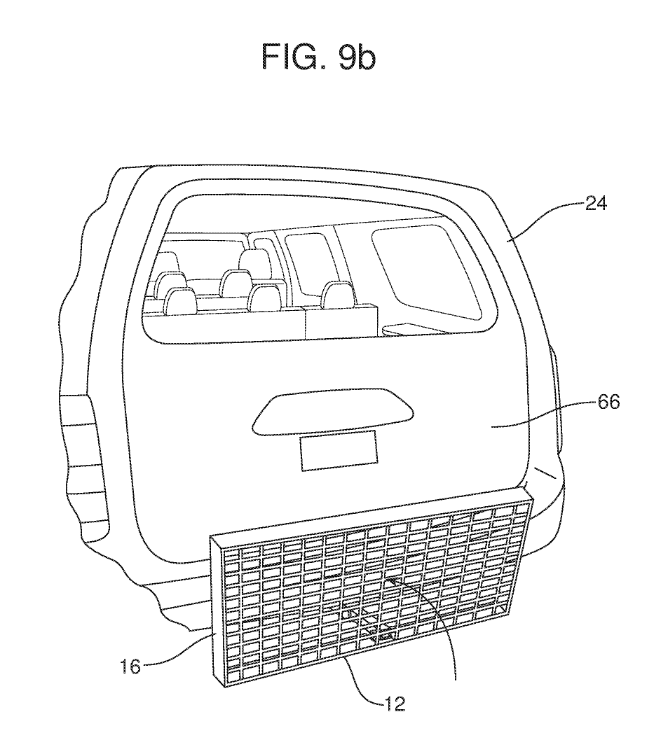

Further, as illustrated in FIGS. 9, 9a and 9b the hitch bar 34 may be pivotally connected to the grate 12 by means of a clevis 62 and pivot pin 64 if desired. Thus, the hitch bar 34 may be pivoted between the stowed position illustrated in FIG. 9 and the two use positions illustrated in FIGS. 9a and 9b. As illustrated in FIG. 9a, the grate 12 is held in a horizontal position to carry cargo behind the lift gate 66. In contrast, in FIG. 9b, the grate 12 has been pivoted into a vertical orientation adjacent the lift gate 66 so as to allow better access to the tailgate and the rear of the SUV 24.

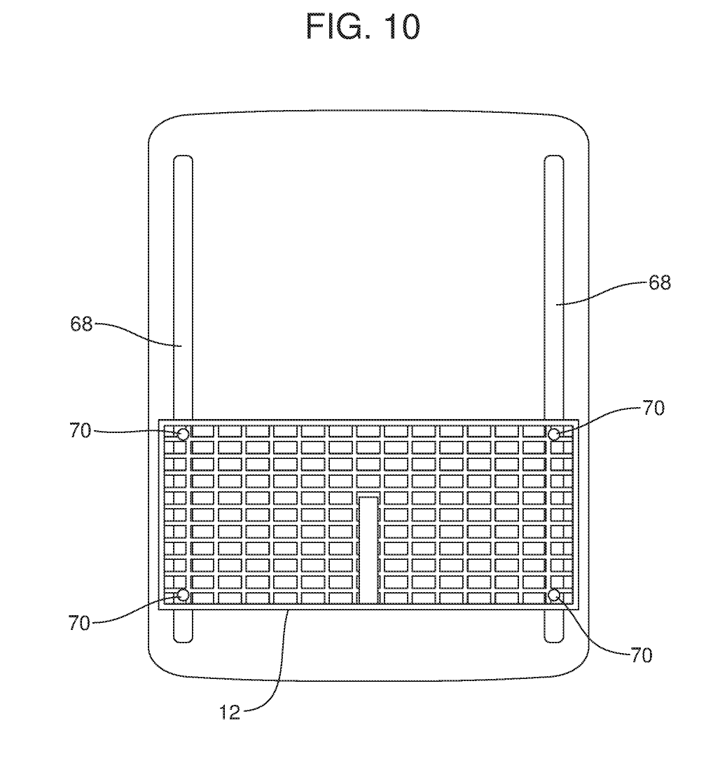

As illustrated in FIG. 10, the grate 12 may be attached to the roof rails 68 of the motor vehicle 24 by means of the bolts 70. Thus, the grate 12 may also function as a “roof basket” to hold gear on the roof of the motor vehicle 24 when desired.

All such modifications and variations are within the scope of the appended claims when interpreted in accordance with the breadth to which they are fairly, legally and equitably entitled.

What is claimed:

1. A cargo management system for a motor vehicle, comprising:
a grate displaceable between a first use position mounted inside said motor vehicle and a second use position mounted outside said motor vehicle.

2. The cargo management system of claim 1, wherein said grate includes a hitch bar.

3. The cargo management system of claim 2, wherein said hitch bar is displaceable between a stored position and a deployed position.

4. The cargo management system of claim 3, further including a receiver in said motor vehicle for receiving and holding said grate in said first use position.

5. The cargo management system of claim 4, wherein said receiver comprises opposed slide channels and said grate is held in said opposed slide channels in said first use position.

6. The cargo management system of claim 5, wherein said hitch bar is held in said storage position when said grate is in said first use position.

7. The cargo management system of claim 6, wherein said grate includes a support tube and said hitch bar is received in said support tube in a telescoping manner.

8. The cargo management system of claim 7, further including a storage pan in said floor under said grate when said grate is in said first use position.

9. The cargo management system of claim 8, further including a latch mechanism securing said grate in said first use position over said storage pan.

10. The cargo management system of claim 7, further including a perimeter flange around said grate wherein said perimeter flange projects from said grate around a first face of said grate.

11. The cargo management system of claim 10, wherein said hitch bar is in said deployed position and is received in a hitch receiver of said motor vehicle when said grate is in said second use position.

12. The cargo management system of claim 11, wherein said first face is oriented upward when said grate is in said second use position.

13. The cargo management system of claim 12, wherein said perimeter flange includes an integrated bicycle mount.

14. The cargo management system of claim 13, wherein said integrated bicycle mount includes a tubular bead formed in said perimeter flange at a first end of said grate and a notch formed in a second, opposite end of said grate.

15. The cargo management system of claim 14, further including a skewer received in said circular bead and a strap for securing a wheel of a bicycle in said notch.

16. The cargo management system of claim 2, further including a receiver in said motor vehicle for receiving and holding said grate in said first use position.

17. The cargo management system of claim 16, wherein said receiver comprises opposed slide channels and said grate is held in said opposed slide channels in said first use position.

18. The cargo management system of claim 17, further including a storage pan in said floor under said grate when said grate is in said first use position.

19. The cargo management system of claim 18, further including a latch mechanism securing said grate in said first use position over said storage pan.

20. The cargo management system of claim 19, further including a perimeter flange around said grate wherein said perimeter flange projects from said grate around a first face of said grate.
